(19) United States
(12) Patent Application Publication
(10) Pub. No.: US 2008/0123127 A1
(43) Pub. Date: May 29, 2008

(54) Image processing apparatus

(75) Inventors: Yuji Okamoto, Kyoto (JP); Naofumi Ueda, Kyoto (JP); Tsutomu Yoshimoto, Nara (JP); Syoichiro Yoshiura, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/811,110

(22) Filed: Jun. 8, 2007

(30) Foreign Application Priority Data
Jun. 9, 2006 (JP) 2006-160882

(51) Int. Cl. G06F 15/00

(52) U.S. Cl. 358/1.14

(57) ABSTRACT

The present invention prevents a third party's unauthorized use by rendering a image processing apparatus having a security function undistinguishable from an image processing apparatus without a security function. In a copy mode, the image processing apparatus reads image data of a copy and stores inputted image data in a hard disk drive. The image processing apparatus prints the image data. Once the printing is finished, the image data is erased by operation of the security function. In this case, a disguise section makes a disguise to look as if the security function is not provided by not indicating that the image data is being erased on an operation screen.

### BACKGROUND OF THE INVENTION

1. Field of the Invention

The present invention relates to an image processing apparatus for performing processes such as copying, printing and data transmission of image data.

2. Description of the Related Art

An image processing apparatus performs a variety of image processing, such as a copy mode, a print mode, a scanner mode and a facsimile mode. Such an image processing apparatus is connected to a server or a personal computer through a network so as to transmit and receive image data. For that reason, there is an increasing danger of leaking the image data due to unauthorized access and invalid operation from outside.

Thus, the image processing apparatus has a security function to prevent leakage of the image data. The image processing apparatus makes an appeal as to its security function by labeling it or displaying a security mark on an operation screen. As described in Japanese Patent Laid-Open No. 2005-204242 for instance, it is indicated on the operation screen that the security function is being executed during image processing operation. A user can have a sense of ease by recognizing execution of the security function. It also has an effect of preventing a third party's unauthorized use.

As for an image processing apparatus which does not have the security function, no indication is performed as to security. Therefore, it is easy to discern whether or not the apparatus has the security function. For that reason, a malicious third party can easily obtain the image data by finding the image processing apparatus without the security function and performing invalid operation. Especially, in the case where the image processing apparatuses having the security function and the image processing apparatuses without the security function are mixed in an image processing system connecting multiple image processing apparatuses with external apparatuses such as servers in a network, they can be easily distinguished and there is a possibility that the image processing apparatuses without the security function may be wrongfully used.

Thus, in view of the above, an object of the present invention is to provide an image processing apparatus that can prevent a third party's unauthorized use by rendering it undistinguishable from the image processing apparatuses without the security function.

### SUMMARY OF THE INVENTION

The present invention includes: a processing section for processing image data; a specific processing section for executing a specific function of performing specific processing to the image data; and a disguise section for disguising existence of the specific function.

The disguise section hides operation related to the specific function not only when the specific function is executed but also when the specific function is not executed, so that its existence cannot be known to a third party. When the specific processing section is not operating, the disguise section prohibits annunciation of information on the specific function and performs no annunciation.

When the specific function is executed by the operation of the specific processing section, the disguise section disguises the annunciation relating to the operation. As for the disguised annunciation, only normal annunciation is performed without announcing that the specific function is being executed or false annunciation is performed as if operation totally unrelated to the specific function is being executed.

Thus, the existence of the specific function is not known to the third party. It becomes impossible to distinguish between the image processing apparatus having the security function and the image processing apparatus without the security function, so that the third party hesitates to perform unauthorized use. Thus, a third party's unauthorized use is prevented.

The processing section reads the image data from a document, and the disguise section operates during processing of the read image data. To be more specific, a specific function such as encryption of image data is executed when storing inputted image data in a copy mode or a scanner mode. However, the disguised annunciation is performed by the disguise section so as to hide that the specific function is being executed.

The processing section prints the image data, and the disguise section operates on printing. To be more specific, a specific function such as erasure of the stored image data is executed when the image data is printed in the copy mode or a print mode. However, the disguised annunciation is performed by the disguise section so as to hide that the specific function is being executed.

The disguise section operates on start-up. To be more specific, on start-up, initialization is performed and the specific function such as erasure of the remaining image data is executed. However, the disguised annunciation is performed by the disguise section so as to hide that the specific function is being executed. When turning on power and starting it up, the third party does not notice that the specific function is provided.

An input section for receiving an input of an operating instruction is provided. The input section allows the input of an operating instruction when the disguise section is operating. To be more specific, an operating instruction can be inputted even when the specific function is being executed. For that reason, execution of the specific function is disguised.

When the specific processing section is operating, the processing section puts execution of a received operating instruction on standby. The specific function is executed without interruption. As the disguised annunciation is performed during this time, the third party does not notice that the specific function is executed.

The specific processing section operates when the processing section is not operating. The specific function is not executed when the operating instruction is inputted and the processing section is operating. The specific function is executed when the processing section is not operating. Thus, image processing can be efficiently performed.

A setting section for setting whether to enable or disable the disguise section is provided. It can be freely selected whether or not to perform the disguise, and the setting can be made according to a purpose of use and a use environment of the image processing apparatus. In this case, setting by the setting section is allowed when a specific operation is performed. The specific operation allows setting of whether to enable or disable the disguise, and the setting is prohibited when no specific operation is performed. Thus, the setting can be performed only by a user who knows the specific operation such as a manager, and a general user who does not know the specific operation cannot perform the setting.

According to the present invention, a disguise is performed as to the fact that a specific function such as the security function is provided so as to disguise its existence. Therefore, the third party becomes concerned over whether or not the specific function is provided so that an effect of preventing unauthorized use can be obtained. Especially, it becomes difficult to distinguish between the image processing apparatuses having the specific function and the image processing apparatuses without the specific function in an image processing system where both the apparatuses are mixed. For that reason, it takes time and effort to discern the apparatuses, and so a third party's unauthorized use can be prevented.

### BRIEF DESCRIPTION OF THE DRAWINGS

FIG. 1 is a diagram showing a schematic configuration of an image processing apparatus of the present invention;

FIG. 2 is a diagram showing an ordinary operation panel;

FIG. 3 is a diagram showing an operation screen displaying information on a security function;

FIG. 4 is a diagram showing a disguised operation panel;

FIG. 5 is a flowchart in the case of performing a disguised display in a copy mode;

FIG. 6 is a diagram showing a screen displayed during erasure of data;

FIG. 7 is a flowchart in the case of performing a disguised display in a scan mode;

FIG. 8 is a flowchart in the case of performing a disguised display on turning on power; and

FIG. 9 is a diagram showing a screen displayed during initialization.

### DETAILED DESCRIPTION OF THE PREFERRED EMBODIMENTS

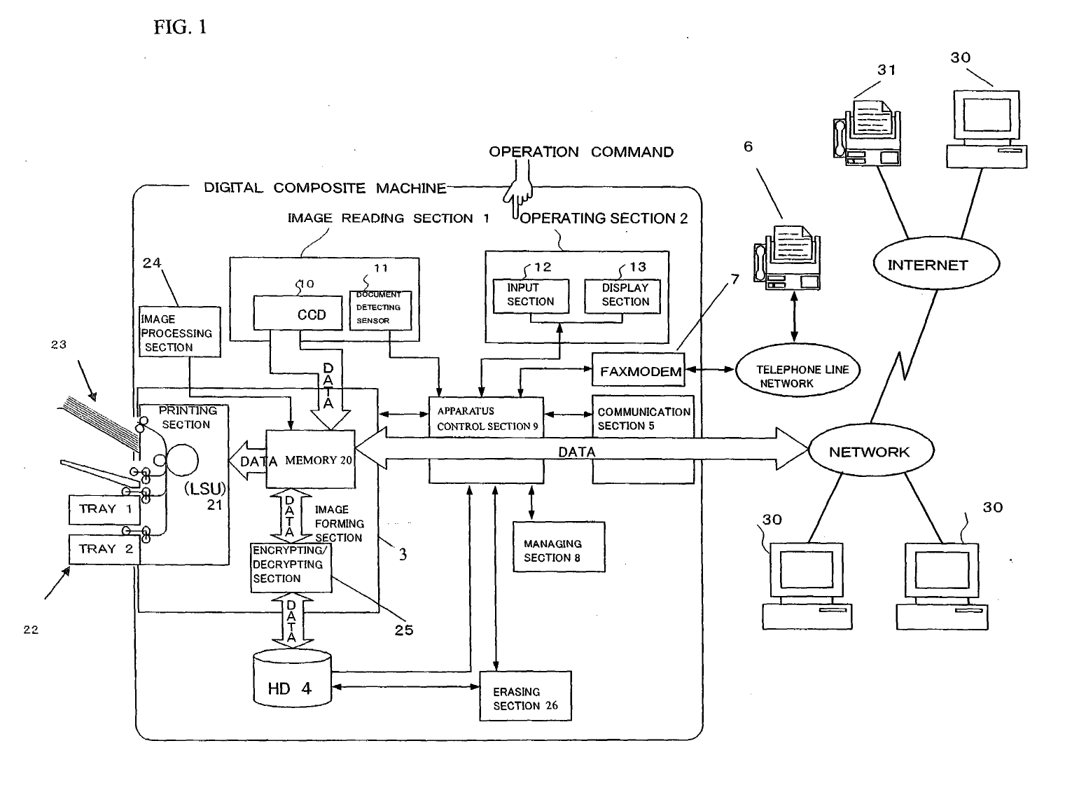

FIG. 1 shows an image processing apparatus of this embodiment. This image processing apparatus is a digital complex machine including a copy mode, a print mode, a scanner mode and a facsimile mode, comprising an image reading section 1 for reading a document and inputting image data, an operating section 2 for receiving an input of a user, an image forming section 3 for printing inputted image data, a hard disk drive 4 for storing the image data, a communication section 5 for performing data communication with external devices, a FAX modem 7 for communicating with a facsimile apparatus 6, a management section 8 for storing control information and setting information on the entire apparatus, and a device control section 9 composed of a CPU for controlling the entire apparatus.

The image reading section 1 functions as an image data input section for inputting the image data, and includes image pickup devices such as a CCD 10 and a document detection sensor 11 for detecting a document set on a copy tray or an automatic copy feeder (ADF). The image data of images read by the CCD 10 is outputted to the image forming section 3.

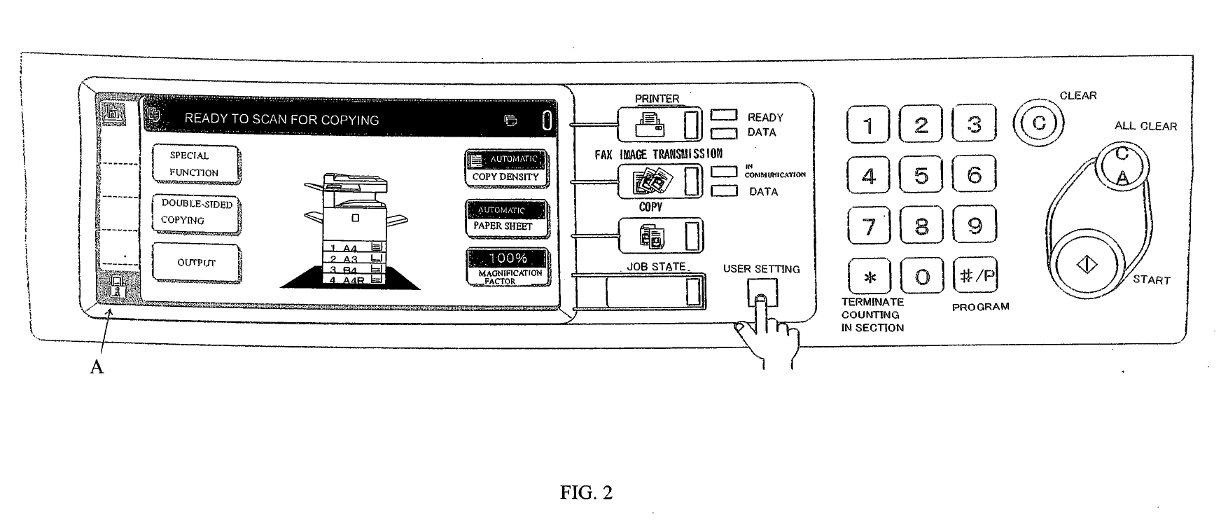

The operating section 2 includes an operation panel shown in FIG. 2, and has an input section 12 composed of various input keys and a display 13 such as a liquid crystal display. The display 13 is a touch panel which also functions as an input section. Operating instructions and various settings of the entire apparatus are inputted on the operating section 2, where input contents and operating conditions of the entire apparatus are displayed. The operating section 2 functions as an input section for receiving inputs of operating instructions.

The image forming section 3 includes a memory 20 for storing the inputted image data, a printing section 21 including a laser scanning unit, a paper feed section 22 having a manual tray and a cassette tray, a paper ejection section 23 having a paper ejection tray, an image processing section 24 and an encryption/decryption section 25.

The memory 20 uses a readable and writable semiconductor memory such as an SDRAM or a flash memory. The memory 20 is divided into an area for storing the inputted image data and an area for storing the image data to be outputted. It is also possible to use two memories 20 for input and for output respectively instead of dividedly using one memory 20.

In the image forming section 3, the inputted image data is stored in the memory 20. The memory 20 stores the image data by overwriting old image data with new image data. The image data undergoes image processing such as compression, extension and modification by the image processing section 24 so as to be stored in the memory 20. The image data having undergone the image processing is outputted to the printing section 21, the hard disk drive 4 or the device control section 9. The printing section 21 prints the images on recording sheets supplied from the paper feed section 22 based on the image data stored in the memory 20. Thus, the image forming section 3 functions as a processing section for processing the image data.

The communication section 5 is connected to a router, a switching hub and the like via a LAN cable, and is also connected to a network formed by information processing apparatuses 30 such as personal computers and servers. The network is connected to the Internet via communication lines such as a telephone line network and optical fibers. The communication section 5 transmits and receives data to and from the information processing apparatuses 30 in the network, and also transmits and receives data and e-mail to and from external information processing apparatuses 30 through the Internet. The communication section 5 further performs Internet facsimile communication with a facsimile apparatuses 31 through the Internet. The FAX modem 7 is connected to the telephone line network via a telephone line, and performs facsimile communication with the external facsimile apparatus 6.

Thus, an image processing system is configured by the external apparatuses and multiple image processing apparatuses which are connected through the network. The image data is transmitted and received among the apparatuses.

The communication section 5 and FAX modem 7 receive the image data from the external apparatuses such as the information processing apparatuses 30, facsimile apparatuses 6 and 31 and input the image data. To be more specific, the communication section 5 and FAX modem 7 function as an image data input section. When the image data is inputted from the external apparatuses, the communication section 5 simultaneously receives the input of operating instructions so as to function as the input section as well. Furthermore, the communication section 5 and FAX modem 7 transmit the image data to the external apparatuses and thereby function as the processing section.

The device control section 9 executes a job to the inputted image data. More specifically, the device control section 9 processes the inputted image data by controlling each section, based on the information stored in the management section 8, according to the input from the operating section 2 and data input from the external apparatuses. Upon execution of the job, one of the copy mode, print mode, scanner mode and facsimile mode is executed according to the inputted image data, and the image is outputted in a desired form.

The hard disk drive 4 temporarily stores the image data. The encryption/decryption section 25 encrypts or decrypts the image data. When the image data is stored in the hard disk drive 4, the image data is encrypted by the encryption/decryption section 25. When reading the encrypted image data from the hard disk drive 4, the image data is decrypted.

The hard disk drive 4 stores management information on data processing as the data other than the image data. The management information includes filing management information, destination management information and history management information. The filing management information is a list of files in which the inputted image data is stored. The destination management information is a list of destinations in facsimile communication. The history management information is a list of executed process contents.

An erasure section 26 for erasing the image data of the hard disk drive 4 is provided. The image data to be erased is the data stored in a processing task area. The device control section 9 controls operation of the erasure section 26 after processing and outputting the image data. The erasure section 26 overwrites random data and meaningless data or erases the data, thereby rendering the stored image data unreadable, and invalidates the data so that an original image cannot be reproduced. As for the memory 20, the erasure section 26 may also invalidate the image data therein by overwriting and erasing old image data or erasing the image data. The management information stored in the hard disk drive 4 is not erased unless there is an instruction from the device control section 9.

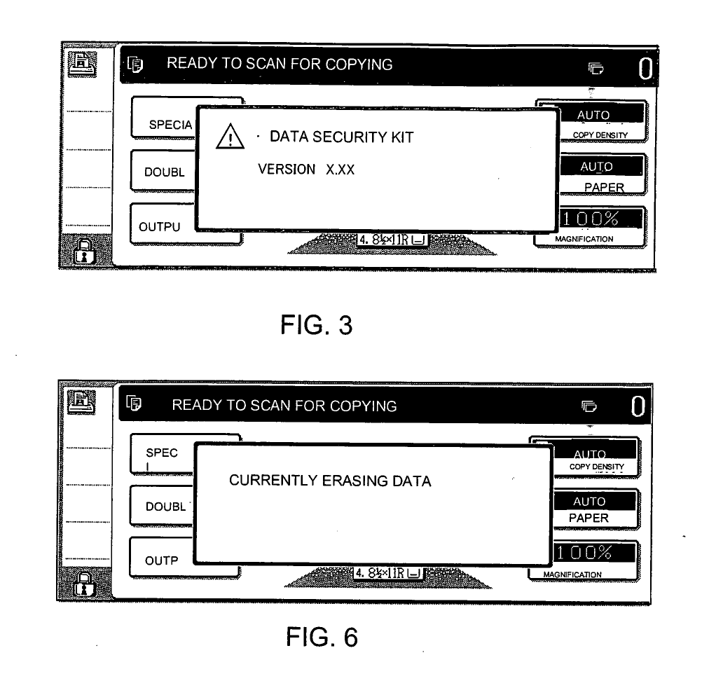

Here, a security function exists to prevent leakage of the image data and protect it. As shown in FIG. 2, in the case of the image processing apparatus having the security function, a security mark A is displayed on the operation screen displayed on the display. The mark A is the operation key for security. When the operation key is operated, the information on the security function is displayed on the operation screen as shown in FIG. 3.

The device control section 9 includes a specific processing section for executing the security function. As for operation by the security function, the following are included: erasing the image data stored in the hard disk drive 4 and memory 20 by the erasure section 26 on finishing a job; encrypting the inputted image data by the encryption/decryption section 25 and then storing it in the hard disk drive 4 and memory 20; erasing the image data stored in the hard disk drive 4 and memory 20 by the erasure section 26 on turning on power; and encrypting and transmitting the image data. The specific processing section performs the above-described operation when the image data is processed.

When such a security function is executed, the device control section 9 announces it by displaying a message indicating that the function is being executed on the display 13. However, the image processing apparatus cannot be distinguished from an image processing apparatus without the security function. The device control section 9 includes a disguise section for disguising existence of the security function.

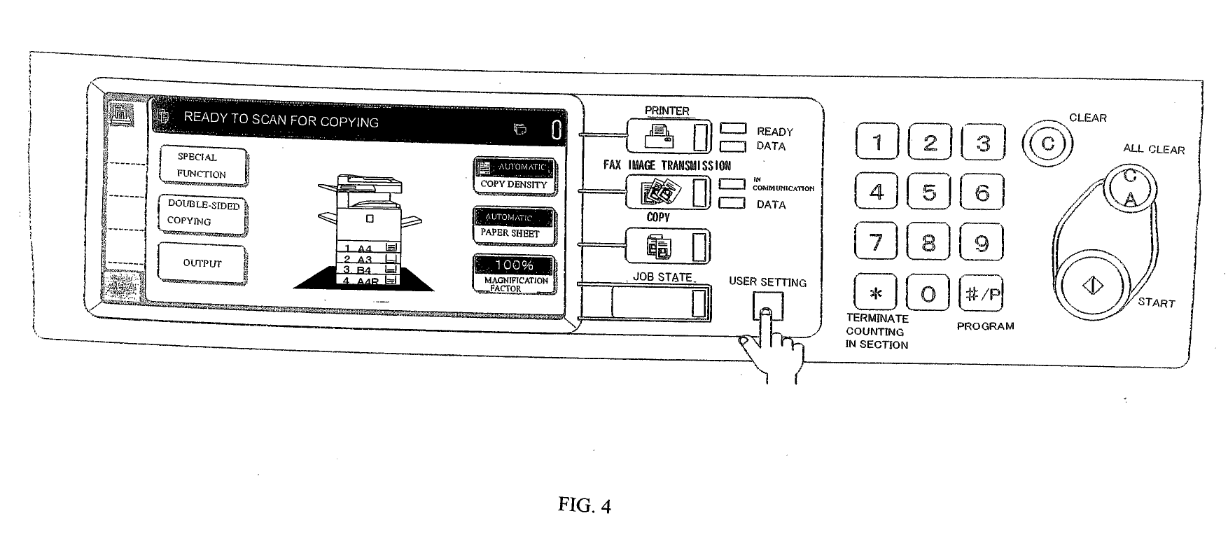

When the security function is executed, the disguise section does not display a message so as not to have a user recognize that the security function is being executed. More specifically, in spite of the security function being executed, the disguise section performs false annunciation to make a disguise to look as if no operation is being performed. The disguise section also operates display 13 and prohibits the display of the security mark A. The security mark A is not displayed on the operation screen as shown in FIG. 4. Thus, on the operation screen, the third party cannot be aware that the security function is provided.

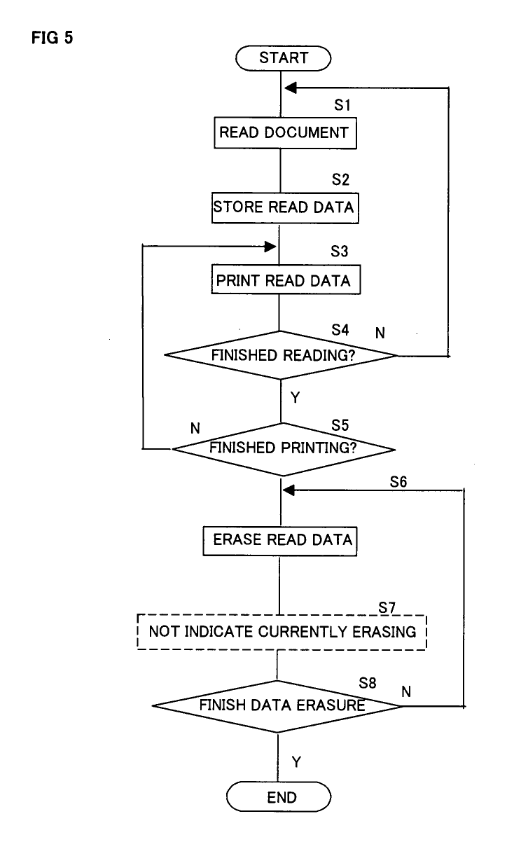

And when executing each of the modes, the disguise section operates. When in the copy mode as shown in FIG. 5, the image data of the document is read by the image reading section 1 (S1). The device control section 9 stores the inputted image data in the hard disk drive 4 (S2). The image data is expanded in the memory 20 and image-processed by the image processing section 24. Thereafter, the image data is outputted to the printing section 21 and printed (S3).

When reading of the entire copy is finished (S4) and the printing is finished (S5), the security function is executed. The image data stored in the hard disk drive 4 is erased by the erasure section 26 (S6). In this case, a message of currently erasing the image data is normally displayed on the operation screen as shown in FIG. 6. However, the message is not displayed due to the operation of the disguise section (S7). If the operation screen in the copy mode is displayed and the erasure of the image data is finished (S8), then the job is finished.

When in the print mode, as same as when in the copy mode, after the image data inputted from the information processing apparatuses 30 is printed, the image data is erased. In this case, the message of currently erasing the image data is not displayed due to the operation of the disguise section.

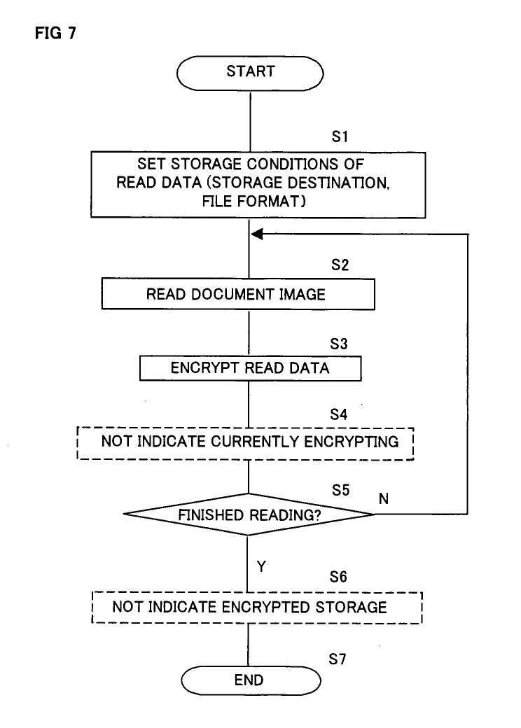

When in the scanner mode as shown in FIG. 7, storage conditions such as a storage destination of the image data to be inputted are set up (S1), and the image data of the copy is read by the image reading section 1 (S2). The device control section 9 stores the inputted image data in the set-up storage destination. In this case, the security function is executed and the image data is encrypted (S3). Normally, a message to the effect that encrypting the image data is in action is displayed on the operation screen. However, the message is not displayed due to the operation of the disguise section (S4). During this time, the operation screen in the scanner mode is displayed.

When reading of the entire copy is finished (S5), a message to the effect that the encrypted image data is being stored is normally displayed on the operation screen. However, the message is not displayed due to the operation of the disguise section (S6), and a normal operation screen is displayed. The encrypted image data is stored in the set-up storage destination, and the job is finished.

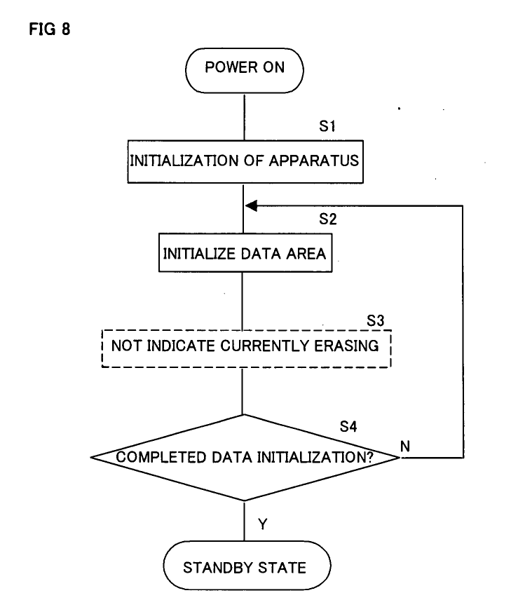

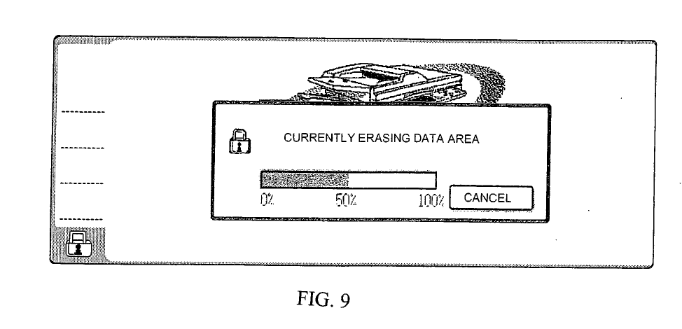

As shown in FIG. 8, the image processing apparatus is initialized when the image processing apparatus is powered on and started up (S1). The security function is executed, and the hard disk drive 4 is initialized. The image data stored in the processing task area of the hard disk drive 4 is erased by the erasure section 26 (S2). Normally, a message of currently erasing the data is displayed on a start-up screen as shown in FIG. 9. However, the message is not displayed due to the operation of the disguise section (S3). The start-up screen is displayed until the initialization is completed (S4). The image processing apparatus is put in a standby state after the initialization is completed.

If an operating instruction is inputted by the user's operation, the operation of image processing is performed. In this case, a message of executing the security function is not displayed even if the security function is executed. More specifically, a disguised display is performed so that the user cannot recognize that the security function is being executed. Therefore, when a malicious third party operates the image processing apparatus, the third party cannot recognize that the security function is provided and has the illusion that the image data is obtainable. In reality, however, the third party cannot obtain the image data due to existence of the security function. It is thereby possible to prevent a third party's unauthorized use and prevent leakage of the image data.

When the security function is being executed, the message stating that the security function is being executed is not displayed by the disguise section. Even during execution of the security function, the device control section 9 allows the input of an operating instruction from the operating section 2 or the external apparatuses so that the user can provide an operating instruction. To be more specific, if an operating instruction is inputted during execution of the security function, the input section stores the contents of the operating instruction in the memory. Thus, the user can input the operating instruction with no sense of discomfort. Consequently, it is possible to render the disguised existence of the security function unnoticeable to the third party.

During execution of the security function, however, the disguise section prohibits operation based on the operating instruction and puts that operation on standby. If the security function is finished, the operation based on the operating instruction is started.

In the case of erasing the image data by the security function during operation of the processing section in each of the modes, priority is given to the operation based on the inputted operating instruction. To be more specific, the specific processing section operates when the processing section is not operating. If printing and transmission of the image data are finished, the erasure section starts operation and erases the stored image data. In this case, the message stating that data is being erased is not displayed due to the operation of the disguise section. Thus, a process of outputting the image data is given priority, so that the two processes will not be performed in parallel.

Therefore, the image data can be efficiently processed without burdening the image processing apparatus.

It is settable whether to enable or disable the above-described disguise section. The device control section 9 includes the setting section for setting whether to enable or disable the disguise section. This setting can be performed by a manager who is permitted based on authentication information such as a password. More specifically, if a specific operation such as inputting a password is performed, the setting section verifies the authentication information inputted by this operation. Upon authenticating the authentication information, it displays the setting screen to set whether to enable or disable the disguise section. When the authentication information cannot be authenticated, the setting screen is not displayed. The specific operation may be an operation for inputting biologic information. The setting section authenticates the biologic information so as to verify whether or not the user is the manager. The specific operation may also be a particular operation of the operation keys, such as sequentially operating multiple operation keys or simultaneously operating multiple operation keys.

Thus, only the manager can perform the specific operation, and so the manager is allowed to set the disguise section. A general user cannot perform the specific operation, and so the general user is not authenticated and the setting by the general user is prohibited. Therefore, when the disguise section is enabled, only the manager recognizes that the security function is provided while other users recognize that the security function is not provided.

Even if the image processing apparatuses having the security function and the image processing apparatuses without the security function are mixed in an image processing system including multiple image processing apparatuses, it appears on the surface that none of the image processing apparatuses has the security function. Therefore, it is not possible to distinguish between the image processing apparatuses having the security function and the image processing apparatuses without the security function. As a result, an image processing system of high security can be constructed, which has the effect of preventing the unauthorized use even if the security function is not provided.

Here, apparatus information on the image processing apparatuses is displayed on the external apparatuses such as the information processing apparatuses connected through the network. The apparatus information includes the information on the security function. The external apparatuses obtain the apparatus information from the image processing apparatuses and display the apparatus information. Thus, the disguise section transmits the apparatus information which disguises the information on the security function to the external apparatuses.

Therefore, the information on the security function is not displayed on the external apparatuses.

When the third party accesses the image processing apparatus by using the external apparatus, the information on the security function is not displayed in the apparatus information of the image processing apparatus. Even if the third party attempts to output the image data by providing an operating instruction to the image processing apparatus, the third party cannot perform the unauthorized use of the image data because the security function such as encryption is executed to the image data.

The present invention is not limited to the above-described embodiment. It is possible, as a matter of course, to add a large number of modifications and changes to the embodiment within the scope of the present invention. As an image processing apparatus, it may be either a complex machine including a copy mode and a print mode or a dedicated machine of only a single mode such as a copier, a scanner or a printer.

The disguise section may perform a false display during execution of the security function. For instance, the disguise function may display a message of executing an operation unrelated to the operation by the security function. The third party cannot be aware that the security function is being executed, so that the existence of the security function can be kept unknown to the third party.

There is a filing function, for instance, as a specific function other than the security function. The filing function stores the image data in the hard disk drive so as to manage and reuse the image data. The disguise section disguises the existence of the stored image data. More specifically, the disguise section does not display a list of the image data so as not to allow what image data is stored to be viewed. It is thereby possible to prevent an unauthorized output of the image data by the third party and prevent leakage of the image data.

What is claimed is:

1. An image processing apparatus comprising:
a processing section for processing image data;
a specific processing section for executing a specific function of performing specific processing to the image data; and
a disguise section for disguising existence of the specific function.

2. The image processing apparatus according to claim 1, wherein when the specific processing section operates, the disguise section disguises annunciation related to operation thereof.

3. The image processing apparatus according to claim 2, wherein
the processing section reads the image data from a document; and
the disguise section operates during processing of the read image data.

4. The image processing apparatus according to claim 2, wherein
the processing section prints the image data; and
the disguise section operates on printing.

5. The image processing apparatus according to claim 2, wherein the disguise section operates on start-up.

6. The image processing apparatus according to claim 1, further comprising an input section for receiving an input of an operating instruction, wherein the input section allows the input of an operating instruction when the disguise section operates.

7. The image processing apparatus according to claim 6, wherein the processing section puts execution of the received operating instruction on standby when the specific processing section operates.

8. The image processing apparatus according to claim 3 or 4, wherein the specific processing section operates when the processing section does not operate.

9. The image processing apparatus according to claim 1, wherein the disguise section prohibits a display of information on the specific function.

10. The image processing apparatus according to claim 1, further comprising a setting section for setting whether to enable or disable the disguise section.

11. The image processing apparatus according to claim 10, wherein setting by the setting section is allowed when a specific operation is performed.
